(19) United States
(12) Patent Application Publication
(10) Pub. No.: US 2005/0240575 A1
(43) Pub. Date: Oct. 27, 2005

(54) Contents search service providing system, contents search service providing method, and contents search service providing program

(76) Inventor: Shigeru Iida, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/932,090

(22) Filed: Sep. 2, 2004

(30) Foreign Application Priority Data
Apr. 23, 2004 (JP) 2004-128261

(51) Int. Cl. G06F 7/00

(52) U.S. Cl. 707/3

(57) ABSTRACT

An efficient contents search service is provided according to a particular contents purchase or contract history of the user.

A system is constructed of: a search request accepting unit 10 that accepts, from a user terminal 200, a contents search request at least including both user information and a search keyword; a user checking unit 11 that conducts a user checking process in a user information database 111, based on the user information included in the contents search request; a history extraction unit 12 that searches a purchase history database 113 for the user checked by the user checking process, and extracts a purchase history of that user; a contents identification unit 13 that conducts a contents search in a contents database 110, based on the purchase history of the user, and identifies the purchased or contracted contents of the user as the contents to be searched for; a search implementing unit 14 that conducts the search process based on the search keyword, targeted for the contents that are to be searched for in a full-text search database 112, and acquires search results; and an output processor 15 that outputs the search results to the user terminal 200.

### CLAIMS OF PRIORUTY

The present application claims prority from Japanese application serial no. 2004-128261, filed on Apr. 23, 2004, the content of which is hereby incorporated by reference into this application.

### BACKGROUND OF THE INVENTION

1. Field of the Invention

The present invention relates to a contents search service providing system, a contents search service providing method, and a contents search service providing program.

2. Description of the Related Art

Searching technologies on contents are proposed. For example, a network-based electronic contents selling system (see Patent Reference Japanese Patent Laid-Open No. 2003-122969) is also proposed that has a contents provider computer installed by a contents provider who sells electronic contents, and a user computer installed by a user who purchases the electronic contents, and functions by connecting the contents provider computer and the user computer via a network. In this electronic contents selling system, the contents provider computer includes: a contents provider-use contents storage unit for storing the individual electronic contents to be sold; a contents provider-use bibliographic database storage unit for storing bibliographic information/data into the above individual electronic contents in a condition associated with these electronic contents, in a database format; a search processor for searching for a database within the contents provider-use bibliographic database storage unit in accordance with a search request from the user computer, and transmitting obtained search results to the user computer; and a contents providing unit for transmitting both of the to-be-transmitted electronic contents stored within the contents provider-use contents storage unit, and bibliographic information/data associated with the to-be-transmitted electronic contents stored within the contents provider-use contents storage unit, to the user computer in accordance with a transmission request from the user computer. The above-mentioned user computer includes: a user-addressed contents storage unit for storing the electronic contents provided from the contents provider computer; a user-addressed bibliographic database storage unit for storing the bibliographic information/data provided from the contents provider computer, in a database format; a contents reproduction unit for reproducing and presenting to the user in accordance with instructions of the user, the required electronic contents within the user-addressed contents storage unit; a contents search unit for, in accordance with instructions of the user, searching for a database within the user-addressed bibliographic database storage unit and presenting the results to the user; and a communications processor having the functions that issue a search request to the search processor in accordance with instructions of the user, present to the user the search results transmitted from the search processor, issue a transmission request to the contents providing unit in accordance with instructions of the user, store the electronic contents transmitted from the contents providing unit, into the user-addressed contents storage unit, and store the bibliographic information/data transmitted from the contents providing unit, in a database format into the user-addressed bibliographic database storage unit.

Additionally, a remote archival system for purchased electronic book data is proposed (see Japanese Patent Laid-Open No. Hei 7-129604). This archival system has: means for recording, on a user-by-user basis, catalogs of the electronic book data that the user has purchased in the past; means for extracting a catalog of the user-purchased electronic book data from the above recording means and displaying the catalog; means for selecting necessary electronic book data from the catalog of the purchased electronic book data, extracted by the above extraction means; and extraction and transfer means for extracting, from the electronic book data library of a Supply Center, the user-purchased electronic book data selected by the above selection means, and transferring the electronic book data to the electronic book memory of the user. This allows the user-purchased electronic book data to be transferred to the electronic book memory of the user, as appropriate, for him/her to view the data.

### SUMMARY OF THE INVENTION

For example, to provide an on-network search service on various such contents as those of books and magazines, a method is proposed that allows a service providing system to conduct a search targeted for all contents in a contents database and present the results of the search to a user who requested the search. However, the contents stored within the database usually amount to vast quantities, and the search results presented to the search-requesting user are also liable to amount to great volumes of data, irrespective of whether the results are desired ones. To the search-requesting user, therefore, search efficiency has never been high enough, since it has taken great deals of time and labor for the user to seek for the desired contents from the large quantities of search results.

The present invention was made in view of the above problem, and is intended mainly to provide a contents search service providing system, contents search service providing method, and contents search service providing program allowing an efficient contents search service to be provided according to a particular contents purchase or contract history of a user.

The contents search providing system for solving the above problem, according to an aspect of the present invention, is a system providing a search service on user-purchased or user-contracted contents, and allowing the use of a contents database in which contents are stored, a full-text search database of the contents, a user information database that stores user information, and a purchase history database that stores a contents purchase or contract history of the user, wherein the above system has: a search request accepting unit for accepting a contents search request at least including both user information and a search keyword, from a user terminal; a user checking unit for conducting a user checking process in the user information database, based on the user information included in the contents search request; a history extraction unit for searching the purchase history database for the user checked by the user checking process, and extracting a purchase history of that user; a contents identification unit for conducting a contents search in the contents database, based on the purchase history of the user, and identifying the purchased or contracted contents of the user as the contents to be searched for; a search implementing unit for conducting the search process based on the search keyword, targeted for the contents that are to be searched for in the full-text search database, and acquiring search results; and an output processor that outputs the search results to the user terminal.

The contents search providing method according to another aspect of the present invention is a method for providing a search service on user-purchased or user-contracted contents, by using an information-processing apparatus which allows the use of a contents database in which contents are stored, a full-text search database of the contents, a user information database that stores user information, and a purchase history database that stores a contents purchase or contract history of the user, wherein the above method is implemented by: accepting a contents search request at least including both user information and a search keyword, from a user terminal; conducting a user checking process in the user information database, based on the user information included in the contents search request; searching the purchase history database for the user checked by the user checking process, and extracting a purchase history of that user; conducting a contents search in the contents database, based on the purchase history of the user, and identifying the purchased or contracted contents of the user as the contents to be searched for; conducting the search process based on the search keyword, targeted for the contents that are to be searched for in the full-text search database, and acquiring search results; and transmitting the search results to the user terminal.

The contents search providing program according to yet another aspect of the present invention is a program that causes a search service providing method on user-purchased or user-contracted contents to be implemented by an information-processing apparatus which allows the use of a contents database in which contents are stored, a full-text search database of the contents, a user information database that stores user information, and a purchase history database that stores a contents purchase or contract history of the user, wherein the above program includes the steps of: accepting a contents search request at least including both user information and a search keyword, from a user terminal; conducting a user checking process in the user information database, based on the user information included in the contents search request; searching the purchase history database for the user checked by the user checking process, and extracting a purchase history of that user; conducting a contents search in the contents database, based on the purchase history of the user, and identifying the purchased or contracted contents of the user as the contents to be searched for; conducting the search process based on the search keyword, targeted for the contents that are to be searched for in the full-text search database, and acquiring search results; and transmitting the search results to the user terminal.

In addition, the problems disclosed in the present Application, and solutions thereto will be made apparent and obvious by reference to description of the preferred embodiment of the present invention and to the accompanying drawings.

### BRIEF DESCRIPTION OF THE DRAWINGS

FIG. 1 is a network configuration diagram encompassing the contents search service providing system in the present embodiment;

FIGS. 2A to 2D are diagrams showing the contents database, full-text search database, user information database, and purchase history database, respectively, used in the present embodiment; and

FIG. 3 is a flowchart showing an actual procedure for realizing the contents search service providing method in the present embodiment.

### DETAILED DESCRIPTION OF THE PREFERRED EMBODIMENTS

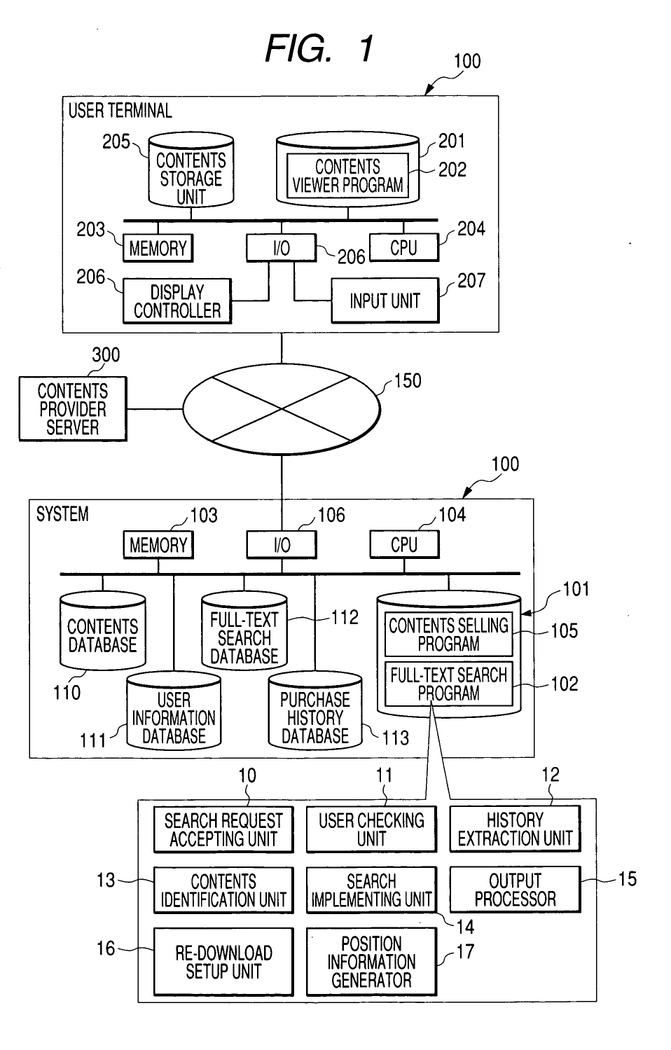

An embodiment of the present invention is described in detail below using the accompanying drawings. FIG. 1 is a network configuration diagram encompassing a contents search service providing system in the present embodiment. The contents search service providing system 100 of the present invention is a server computer. The system 100 reads out into a memory 103 a full-text search program 102 stored within a program database 101 in order to realize a function for implementing the contents search service providing method of the present invention, and executes the program 102 via a CPU 104 which functions as an arithmetic unit. In addition to the full-text search program 102, the system 100 has, and can execute, a contents selling program 105 for selling contents to a user terminal 200 via a network 150. Additionally, the system 100 has an I/O unit 106 that connects to, and exchanges data with, an external apparatus such as the user terminal 200, via the network 150 such as a local-area network (LAN) or the Internet. Furthermore, the system 100 can use a contents database 110, a user information database 111, a full-text search database 112, and a purchase history database 113.

Next, the functional units that the system 100 constructs/holds as, for example, the program 102, are described below. The system 100 has a search request accepting unit 10 that accepts from the user terminal 200 a contents search request at least including both user information and a search keyword. When a contents purchase history of an organization such as a corporate person is stored within the purchase history database 113, the information relating to members of the above organization, linked to the contents purchase history thereof, is registered as the above-mentioned user information in the user information database 111. The search request accepting unit 10 can accept contents search requests from the above members through the user terminal 200.

The system 100 also has a user checking unit 11 that conducts a user checking process in the user information database 111, based on the user information included in the contents search request.

In addition, the system 100 has a history extraction unit 12 for searching the purchase history database 113 for the user checked by the user checking process, and extracting a purchase history of that user. Furthermore, the system 100 has a contents identification unit 13 for conducting a contents search in the contents database 110, based on the purchase history of the user, and identifying the purchased or contracted contents of the user as the contents to be searched for.

Additionally, the system 100 has a search implementing unit 14 for conducting the search process based on the search keyword, targeted for the contents that are to be searched for in the full-text search database 112, and acquiring search results. Besides, the system 100 has an output processor 15 that outputs the search results to the user terminal 200.

When transmitting the search results to the user terminal 200, the output processor can generate a contents viewer starting instruction based on the contents ID that the search results include, and transmit this starting instruction to the user terminal 200.

Additionally, the system 100 can have a re-download setup unit 16 which, for the contents included in the search results, sets up, in the contents database 110, a flag for permission of a re-download into the user terminal 200. At this time, the setup of the flag may be conducted not only in the contents database 110 by way of example, but also for the corresponding contents in, for instance, the user information database 111 or the purchase history database 113.

Furthermore, the system 100 can have a position information generator 17 that extracts the contents included in the search results, from the contents database 110, generates virtual pages by separating the corresponding contents data on a required-size basis, and includes position information within the contents of the search keyword, in the search results, by linking the position information to any one of the virtual pages.

The search implementing unit 14 mentioned above can acquire full-text search results by conducting the full-text search process based on the search keyword, targeted for the contents that are to be searched for in the full-text search database 112. Instead of the full-text search mentioned above, index searching or the like can be adopted as a method of conducting the above search process. The output processor 15 can also be constructed so as to output full-text search results or index search results to the user terminal 200.

The user terminal 200 shown in FIG. 1 is a contents download computer, which, similarly to the system 100, reads out into a memory 203 a contents viewer program 202 stored within a program database 201 in order to realize the functions intended for implementing contents acquisition, a browsing process, and the like, and executes the program 202 via a CPU 204 which functions as an arithmetic unit. The user terminal 200 also has an I/O unit 206 that connects to, and exchanges data with, an external apparatus such as the system 100, via the network 150 such as a LAN or the Internet. Furthermore, the user terminal 200 has a contents storage unit 205 for storing downloaded contents. Besides, the user terminal 200 has a display controller 206 for displaying contents data under the control of the contents viewer, and an input unit 207 for accepting user input, such as a keyboard or a mouse.

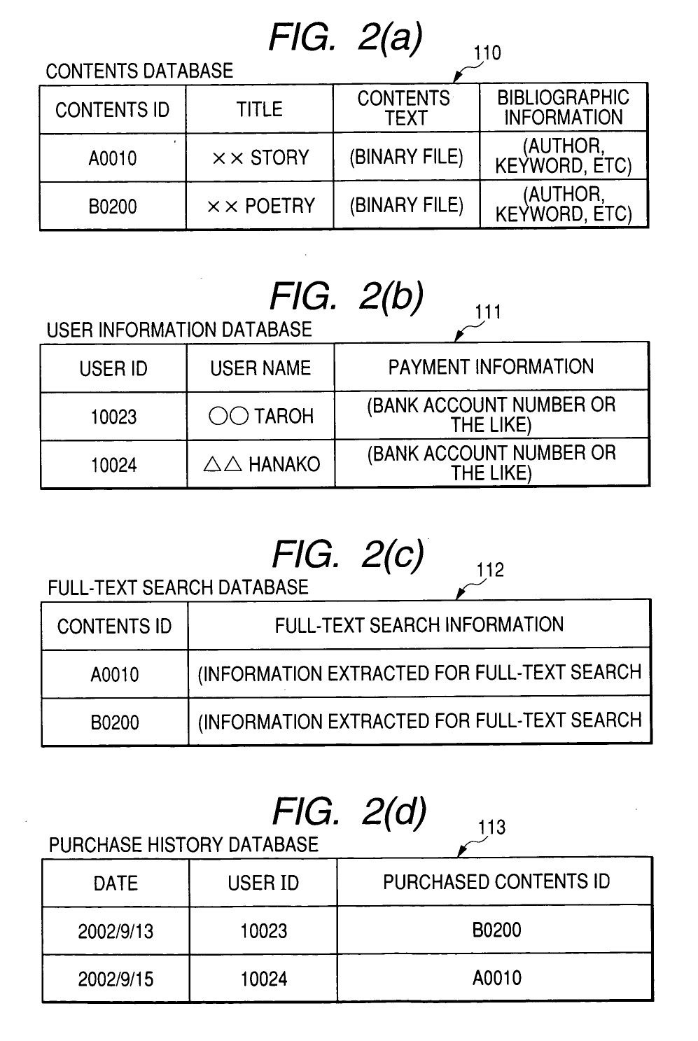

Next, description is given below of the databases that the contents search service providing system in the present embodiment can use. FIGS. 2A to 2D are diagrams showing the contents database, full-text search database, user information database, and purchase history database, respectively, used in the present embodiment. The contents database 110 is a database with stored contents, and this database is a set of records each of which contains a title, a contents main body (text), bibliographic information, and other information are related to one another with, for example, a contents ID as its key.

The user information database 111 is a database that stores user information, and this database is a set of records each of which contains a user name, contents usage charges accounting information, and other information are related to one another with, for example, a user ID as its key.

The full-text search database 112 is a database generated by, for example, the system 100 in order to search for full text of each content, and this database is a set of records each of which contains full-text search information with, for example, a contents ID as its key. The full-text search database 112 is adopted, as appropriate, according to the search method (example: full-text search) that the system 100 employs.

The purchase history database 113 is a database that stores a contents purchase or contract history of a user, and this database is a set of records each of which contains a contents purchase ID and other information are related to one another with, for example, a date or a user ID as its key.

The functional units 10 to 17 in the system, heretofore shown, may be realized as hardware, or may be realized as the programs stored in an appropriate storage device such as a hard-disk drive (HDD) or memory. In the latter case, the CPU 104 reads out the corresponding programs from the storage device into the memory 103 in program execution timing and executes the programs.

Alternatively to the Internet or a LAN, any one of various networks such as a private telephone line, wide-area network (WAN), electric-lighting line network, wireless network, public telephone line network, and cellular phone network, can be adopted as the network 150. Using a virtual private network technology such as VPN (Virtual Private Network) is preferred since, when the Internet is adopted, communication with enhanced security is established.

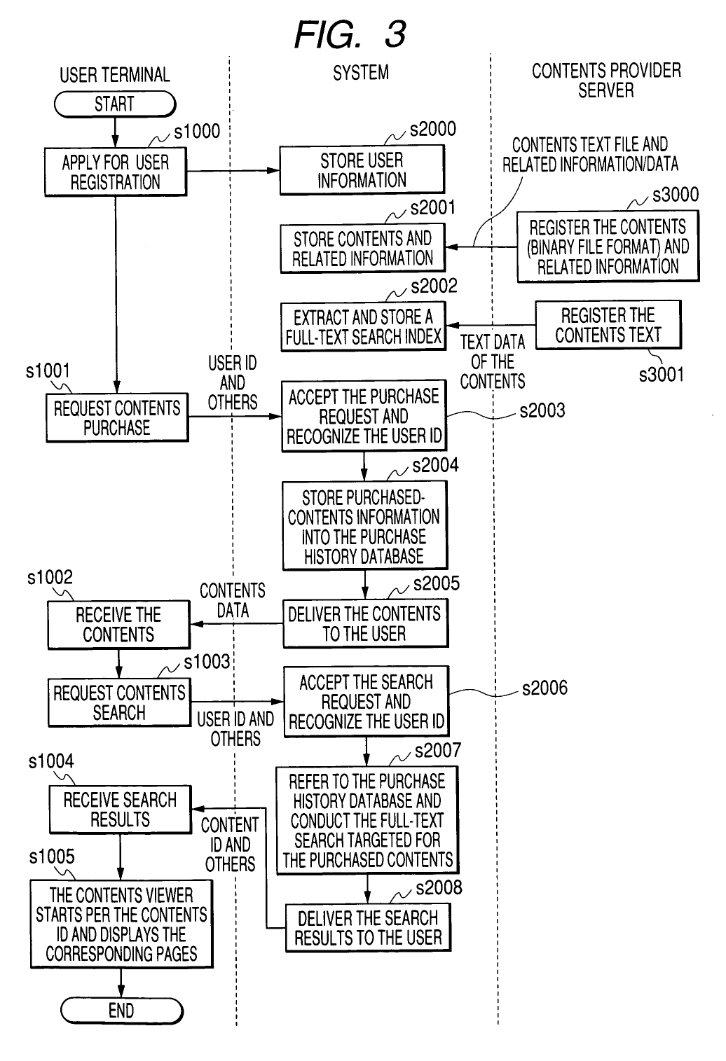

An actual procedure on the contents search service providing method is set forth below in accordance with a flowchart of FIG. 3. The various operational sequences associated with the contents search service providing method, described below, are realized by the program 102 that the system 100 executes by reading out the program into the memory 103. The program 102 contains codes for performing the various operational sequences described below.

In addition to processes associated with the contents search service providing method that the system 100 implements, processes in the user terminal 200 and in a contents provider server 300 (see FIG. 1) are described hereinafter.

It is to be understood that in the present embodiment, while the contents provider server 300 sells contents to the user, the system 100 implements the contents search service providing method of the present invention. Of course, if the progress of contents sale by the system 100 is assumed, functions of the contents provider server 300 may be included in the system 100.

Although in the present embodiment is shown an example in which a full-text search process is employed as the search process based on the above-mentioned search keyword, targeted for the contents that are to be searched for in the full-text search database 112, the method of conducting the search process is not limited to or by the example shown.

During the process flow shown in FIG. 3, processing is first started from application for user registration from the user terminal 200 in the system 100 (step 1000). In the user registration application, for example, a user name, accounting information (such as a bank account for payment of contents usage charges), and other information are transmitted as user information from the user terminal 200. Meanwhile, along with the user registration application, the system 100 receives the user information and stores the information into the user information database 111 (step 2000). This completes the user registration.

The contents provider server 300 for selling contents to the user transmits contents (example: binary file format) and related information (example: a title, bibliographic information, and others of the contents) to the system 100 beforehand (step 3000). The system 100 stores the contents and related information that have been transmitted from the contents provider server 300, into the contents database 110 (step 2001).

Furthermore, the contents provider server 300 transmits text data (text format) of the contents to the system 100 (step 3001). The system 100 receives the text data and performs a full-text search index extraction process on the corresponding contents. The full-text search index thus extracted is stored in a linked condition with respect to the contents ID into the full-text search database 112 by the system 100 (step 2002). A method based on an existing full-text search algorithm can be adopted to extract a full-text search index from text data of contents.

For a user who completed user registration, the system 100 accepts a contents purchase request from the user terminal 200 (step 1001). The system 100 receives the contents purchase request and, for example, after checking against the user information the user ID included in the contents purchase request, conducts user authentication (step 2003). In addition, the system 100 conducts an accounting process for the user-desired contents, based on the accounting information stored within the user information database 111. When accounting is completed, at least the contents ID of the corresponding contents is stored into the purchase history database 113 by the system 100 (step 2004) to indicate that the contents have been purchased. Meanwhile, the system 100 extracts the corresponding data of the purchased contents from the contents database 110 and delivers the data to the user terminal 200 (step 2005).

The user terminal 200 receives in step 1002 the contents delivered from the system 100, and stores the contents into the contents storage unit 205. Also, the user terminal 200 reads out the corresponding contents from the contents storage unit 205 in accordance with the contents display instructions (or the like) accepted from the user via the input unit 207, and outputs the contents from the display controller 206 via the contents viewer program 202.

Assume that the user subsequently issues a further contents search request to search for a desired content from the contents that the user has already purchased. In this case, the user terminal 200 accepts the contents search request from the user and transmits the desired content to the system 100 (step 1003).

The system 100 receives the contents search request and acquires the user information and search keyword included in the request. The system 100 then conducts, in step 2006, a user checking process in the user information database 111, based on the user information.

If a contents purchase history of an organization such as a corporate person is stored within the purchase history database 113, the information relating to members of the above organization, linked to the contents purchase history thereof, is registered as the above-mentioned user information in the user information database 111. In this case, the system 100 can be adapted to accept contents search requests from the above members through the user terminal 200.

The system 100 searches the purchase history database 113 for the user checked by the user checking process, and extracts a purchase history of the user. The system 100 further conducts a contents search in the contents database 110, based on the purchase history of the user, and identifies the user-purchased or user-contracted contents as the contents to be searched for.

Additionally, in step 2007, the system 100 conducts the full-text search process based on the search keyword, targeted for the contents that are to be searched for in the full-text search database 112, and acquires full-text search results. The system 100 delivers the full-text search results to the user terminal 200 (step 2008).

The system 100 can be constructed so that when delivering the full-text search results to the user terminal 200 the system generates a contents viewer starting instruction based on the contents ID that the full-text search results include, and transmit this starting instruction to the user terminal 200. In that case, the user terminal 200 receives the full-text search results from the system 100 (step 1004) and then starts the contents viewer in accordance with the contents ID within the full-text search results (step 1005). Since the corresponding contents are displayed through the contents viewer automatically started in this way, contents browsing by the user can be improved in efficiency and in speed. The full-text search results are output to the user display 200 to complete the flow show in FIG. 3.

The system 100 can also be constructed so that it extracts from the contents database 110 the contents included in the full-text search results, generates virtual pages by separating the corresponding contents data on a required-size basis, and includes position information within the contents of the search keyword, in the search results, by linking the position information to any one of the virtual pages. Unlike the contents of a paper medium, electronic contents may not be initially separated into pages. Therefore, provided that the system 100 implements such a processing concept of virtual pages, even when a full-text search is conducted for contents not separated into pages, identifiability/recognizability of search results can be improved since information of the virtual pages will be appended to the search results presented to the user.

Additionally, the system 100 may be constructed so that for the contents included in the search results, the system sets up, in the contents database 110, a flag for permission of a re-download into the user terminal 200. Execution of such processing by the system makes it possible to enhance the convenience of use of contents at the user side.

According to the present invention, an efficient contents search service can be provided according to a particular contents purchase or contract history of the user.

While a detailed description of an embodiment of the present invention, based on the embodiment, has been given above, the invention is not limited to or by the description and various modifications can be made to the invention without deviating from the scope and spirit thereof.

According to the present invention, it becomes possible to provide an efficient contents search service according to a particular contents purchase or contract history of the user.

1. A contents search service providing system for providing a search service on user-purchased or user-contracted contents,
wherein said system allows use of a contents database in which contents are stored, a full-text search database for the contents, a user information database that stores user information, and a purchase history database that stores a contents purchase or contract history of a user, said system comprising:
a search request accepting unit for accepting from a user terminal a contents search request at least including both user information and a search keyword;
a user checking unit for conducting a user checking process in the user information database, based on the user information included in the contents search request;
a history extraction unit for searching the purchase history database for the user checked by the user checking process, and extracting a purchase history of the user;
a contents identification unit for conducting a contents search in the contents database, based on the purchase history of the user, and identifying purchased or contracted contents of the user as the contents that are to be searched for;
a search implementing unit for conducting the search process based on the search keyword, targeted for the contents that are to be searched for in the full-text search database, and acquiring search results; and
an output processor for transmitting the search results to the user terminal.

2. The contents search service providing system according to claim 1,
wherein when transmitting search results to the user terminal, said output processor generates a contents viewer starting instruction based on the contents ID that the search results include, and transmits the starting instruction to the user terminal.

3. The contents search service providing system according to claim 1, said system further including a re-download setup unit which, for the contents included in the search results, sets up in the contents database a flag for permission of a re-download into the user terminal.

4. The contents search service providing system according to claim 1, wherein:
when a contents purchase history of an organization such as a corporate person is stored within the purchase history database, the information relating to members of the organization, linked to the contents purchase history thereof, is registered as the user information in the user information database; and
said search request accepting unit accepts contents search requests from the members through the user terminal.

5. The contents search service providing system according to claim 1, said system further including a position information generator that extracts from the contents database, the contents included in the search results, generates virtual pages by separating data of the contents on a required-size basis, and includes position information within the contents of the search keyword, in the search results, by linking the position information to any one of the virtual pages.

6. A contents search providing method for providing a search service on user-purchased or user-contracted contents by use of an information-processing apparatus which allows use of a contents database in which contents are stored, a full-text search database of the contents, a user information database that stores user information, and a purchase history database that stores a contents purchase or contract history of a user, said method comprising the step of:
accepting from a user terminal a contents search request at least including both user information and a search keyword;
conducting a user checking process in the user information database, based on the user information included in the contents search request;
searching the purchase history database for the user checked by the user checking process, and extracting a purchase history of the user;
conducting a contents search in the contents database, based on the purchase history of the user, and identifying purchased or contracted contents of the user as the contents that are to be searched for;
conducting the search process based on the search keyword, targeted for the contents that are to be searched for in the full-text search database, and acquiring search results; and
transmitting the search results to the user terminal.

7. A contents search service providing program that causes a search service providing method on user-purchased or user-contracted contents to be implemented by an information-processing apparatus which allows use of a contents database in which contents are stored, a full-text search database of the contents, a user information database for storing user information, and a purchase history database for storing a contents purchase or contract history of the user, said program comprising the steps of:
accepting from a user terminal a contents search request at least including both user information and a search keyword;
conducting a user checking process in the user information database, based on the user information included in the contents search request;
searching the purchase history database for the user checked by the user checking process, and extracting a purchase history of the user;
conducting a contents search in the contents database, based on the purchase history of the user, and identifying purchased or contracted contents of the user as the contents that are to be searched for;
conducting the search process based on the search keyword, targeted for the contents that are to be searched for in the full-text search database, and acquiring search results; and
transmitting the search results to the user terminal.
